(19) United States
(12) Patent Application Publication
(10) Pub. No.: US 2026/0278540 A1
(43) Pub. Date: Sep. 17, 2026

(54) Method for Identifying and Classifying Non- Serialized Parts Using Reference Object Dimensional Determination Image and Attribute Classification with Validation at Various Times in a Parts Lifecycle

(71) Applicant: Aries Freight Systems, LP, Houston, TX (US)

(72) Inventors: Nikhil Nawaz, Spring, TX (US); William Riley Belile, II, Willis, TX (US); Bryan Bartels, Conroe, TX (US)

(73) Assignee: Aries Freight Systems, LP, Houston, TX (US)

(21) Appl. No.: 19/232,781

(22) Filed: Jun. 9, 2025

Related U.S. Application Data
(60) Provisional application No. 63/635,024, filed on Apr. 17, 2024.

(51) Int. Cl. G06Q 10/0875; G06Q 30/018; G06V 10/764

(52) U.S. Cl. CPC G06Q 10/0875; G06Q 30/018; G06V 10/764

(57) ABSTRACT

A computerized system and method for accurately identifying non-serialized parts through integration of artificial intelligence (AI) and machine learning (ML) models with dimensional determination techniques using standardized and non-standardized reference objects. The method involves capturing digital images of parts, performing AI-driven dimensional analysis, and conducting automated image classification to determine part identity. Validation accuracy is further enhanced by leveraging supplemental data including image metadata, geolocation information, real-time inventory data, known part-location correlations, and direct field input. This technical approach significantly improves identification reliability under diverse environmental conditions throughout various stages of a part's logistics lifecycle, ensuring high confidence levels and operational efficiency in supply-chain management.

### CROSS-REFERENCE TO RELATED APPLICATIONS

This application claims the benefit of U.S. Provisional Application No. 65/635,024, filed on Apr. 17, 2024 which is hereby incorporated by reference in its entirety.

### BACKGROUND OF THE INVENTION

Identifying and classifying non-serialized parts, or parts whose serialization is unreadable or unavailable, poses significant challenges during transportation and inventory management stages of their lifecycle, particularly in real-world, in-the-field environments for logistics and supply chain management. Personnel responsible for transporting or organizing the logistics of such parts typically lack comprehensive industry knowledge or familiarity with extensive inventories, which often contain thousands of visually similar parts making accurate visual part identification almost impossible.

Existing approaches, such as simple databases, photographic catalogs, or reliance on experts, fail to effectively address these challenges due to substantial variability in part conditions caused by environmental factors such as soil, rust, and oils, as well as wear and physical damage. Additional limitations include inadequate in-field viewing conditions, inconsistent lighting and viewing angles, and complexity introduced by part assemblies or usage configurations.

Even if a visual catalog or database is available, the absence of reliable validation methods for non-serialized parts based on varying part conditions discussed above leads to high rates of error, inefficiency, and elevated costs due to the need for an onsite technical expertise at multiple locations for proper identification. Consequently, inaccurate or delayed part identification disrupts supply chains, hampers trade compliance documentation, incorrect payment of duties and tariffs, and negatively impacts operational efficiency.

These problems are particularly acute for organizations managing substantial inventories of reusable parts across multiple geographic locations. Therefore, a solution is needed that provides robust, reliable, and efficient methods for accurately identifying non-serialized parts in varied environmental and operational contexts without requiring extensive technical expertise, additional hardware such as RFID tags, or continuous physical access to the parts.

### BACKGROUND OF THE INVENTION

Identifying and classifying non-serialized parts, or parts whose serialization is unreadable or unavailable, poses significant challenges during transportation and inventory management stages of their lifecycle, particularly in real-world, in-the-field environments for logistics and supply chain management. Personnel responsible for transporting or organizing the logistics of such parts typically lack comprehensive industry knowledge or familiarity with extensive inventories, often containing thousands of visually similar parts. Existing approaches, such as simple databases, photographic catalogs, or reliance on experts, fail to effectively address these challenges due to substantial variability in part conditions caused by environmental factors such as soil, rust, and oils, as well as wear and physical damage. Additional limitations include inadequate in-field viewing conditions, inconsistent lighting and viewing angles, and complexity introduced by part assemblies or usage configurations. Even if a visual catalog or database is available, the absence of reliable validation methods for non-serialized parts based on varying part conditions discussed above leads to high rates of error, inefficiency, and elevated costs due to the need for an onsite technical expertise at multiple locations. Consequently, inaccurate or delayed part identification disrupts supply chains, hampers trade compliance documentation, incorrect payment of duties and tariffs, and negatively impacts operational efficiency. These problems are particularly acute for organizations managing substantial inventories of reusable parts across multiple geographic locations. Therefore, a solution is needed that provides robust, reliable, and efficient methods for accurately identifying non-serialized parts in varied environmental and operational contexts without requiring extensive technical expertise or continuous physical access to the parts.

### SUMMARY OF THE INVENTION

The present invention provides a method for identifying and classifying non-serialized parts or where the part serialization is not readable or available for varying parts and in varying conditions of the part's life cycle in-the-field environments during varying environmental conditions throughout the transportation life cycle. The present invention embodies a method to identify non-serialized parts from a company's inventory or subset of parts for use in the supply chain without any technical knowledge or intimate knowledge of the entire part inventory or subset by a hired service provider. The method of employing Artificial Intelligence for identifying and classifying non-serialized parts using reference object dimensional determination image and attribute classification with validation at various stages of the logistics lifecycle allows the continued movement of inventory in the supply chain by unknowledgeable third party for accurate and timely trade compliance and trade documentation completion.

### BRIEF DESCRIPTION OF FIGURES

FIG. 1 is high level graphical representation of the non-serialized in-the-field part identification method including the following method elements: human or computer assisted dimensional determination, computer assisted image identification, human or computer assisted identification refinement, and human or computer part validation.

FIG. 2a is a graphical representation of the method element shown in FIG. 1. Dimensional Determination illustrates four possible methods for determining an unidentified part's dimensions which can be implemented separately or in a combined manner to more accurately determine the part's dimensions using an in-the-field image of the unidentified part or using the actual unidentified part itself.

FIG. 2b is graphical representation of the method of implementing the computer assisted computer identification using an in-the-field image of the unidentified part and implementing a trained Artificial Intelligence or Machine Learning (AI or ML) model for both part image and part attributes.

FIG. 2c graphical representation of the method for implementing part Identification Refinement illustrating various methods, that can be used separately or in a combined manner to improve accuracy or efficiency, for refinement to include four possible implementations of user input, image metadata including geographic metadata, location database information, US Customs entry data separately or combined with job site location data.

FIG. 2d is a graphical representation of the method of Field Validation illustrating both computer and human methods to validate the part number for the unidentified part using the part attribute obtained either from in-the-field observations or from Artificial Intelligence/Machine Learning determination and attribute extraction.

FIG. 3 is a graphical representation illustrating additional examples of using Artificial Intelligence/Machine Learning to improve the accuracy or efficiency of the method by using a trained data library of parts which are further defined and refined in the illustration by additional databases of information that could include subset of parts, purpose use of parts, part location, current inventory of parts, and other relationship databases with part information. The graphical representation illustrates using the said information and databases to create a smaller more accurate and efficient Artificial Intelligence/Machine Learning model for both image recognition and part attribute recognition.

FIG. 4 is an illustration of using a standard and non-standard reference objects in dimensional determination. FIG. 4a illustrates the use of a standard reference object and a nonstandard reference object in an in-the-field observation. FIG. 4b illustrates the use of a photograph of placing standard and nonstandard reference objects in an in-the-field observation. FIG. 4c illustrates a detailed view of standard reference objects.

FIG. 5 illustrates the output of the identification process being performed using AL/ML trained model in the evaluation process using a subset of parts inventory.

### DETAILED DESCRIPTION OF THE PREFERRED EMBODIMENTS

The following detailed description, given by way of example and not intended to limit the invention solely to the embodiments described herein, will best be understood in conjunction with the accompanying drawings, wherein like reference numerals denote like elements and parts throughout the drawings.

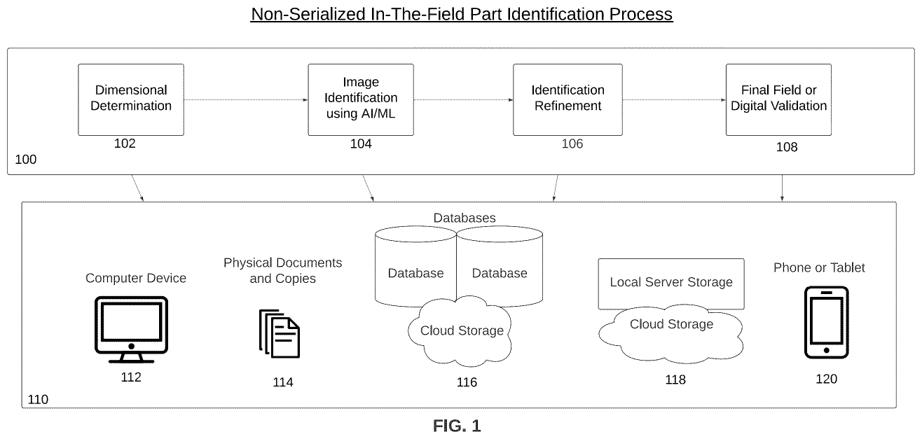

Referring now to the drawings, and in particular to FIG. 1, there is shown an illustration of the non-serialized in-the-field identification process including four separate method elements that can be utilized separately or in combination to identify non-serialized parts or parts in which the serialization is unknown and cannot be used for identification. The FIG. 1 embodiment diagram shows the identification methods illustrated linearly as a preferred embodiment 100 applying first Dimensional Determination 102, then applying Image Identification using Artificial Intelligence/Machine Learning 104, then applying Identification Refinement 106, then applying Field Validation 108.

It is contemplated that other embodiments could apply these methods in different orders and ways, or some methods shown could be excluded completely from the part identification process. For example, one embodiment method could start with Image Identification using Artificial Intelligence/Machine Learning 104 and then apply Identification Refinement 106 and lastly Field Validation 108.

Within the FIG. 1 embodiment diagram 100 data and information can be shared and stored between identification methods in a data layer 110, which could include both physical and meta data and information. FIG. 1 embodiment illustrates the data layer to include information and data to be stored and retrievable on a localized computer, tablet, or phone 112, information and data stored and shared with a physical image and data representations such as photographs and printed documents 114, localized, remote, or cloud databases 116, localized or cloud server storage 118, on a localized device such as a phone or tablet 120.

The preferred embodiment includes the data layer to improve accuracy and efficiency, by storing and sharing data between identification methods which would decrease the number of physical interactions with the unidentified part and allow all identification methods regardless of embodiment or order to occur out of sequence or remotely limiting additional needed part interaction which is critical due to the limited nature of part access during the part's journey in the global supply chain.

The data layer is included in the preferred embodiment to allow the methods of identification to continue during the part's journey in the logistics supply chain even if a part is not physically available for additional evaluation and observation. This is certainly the case, as non-serialized parts physically move throughout the logistics supply chain the number of physical interactions are limited due to packaging, storage within cargo holds on vessels, planes, trains, or trucks. Because the parts are non-serialized they are difficult to identify and distinguish when mixed with other parts, however, the need to accurately identify non-serialized parts for shipment documents, legal compliance, insurance coverage, and US custom and trade compliance without additional physical access. The preferred method herein allows for a single physical interaction, and the use of photograph or digital image of the unidentified part and shared data and information to perform or complete all the identification methods illustrated in FIG. 1 and accurately identify the non-serialized parts throughout the entire supply chain.

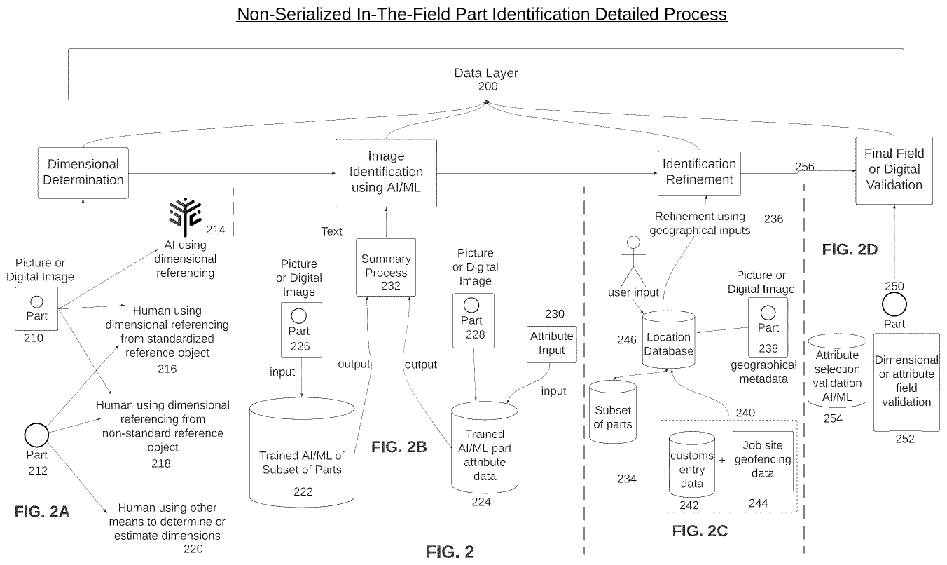

Referring now to FIG. 2a, there is shown an embodiment of a Dimensional Determination identification method illustrating both computer and human processes to complete the identification method. In this illustrated embodiment, the computer and human processes can be implemented together or separately to fulfill the embodiment. The embodiment additionally illustrates that both physical or digital picture of the unidentified part 210 or the actual unidentified part 212 maybe be used for this embodiment.

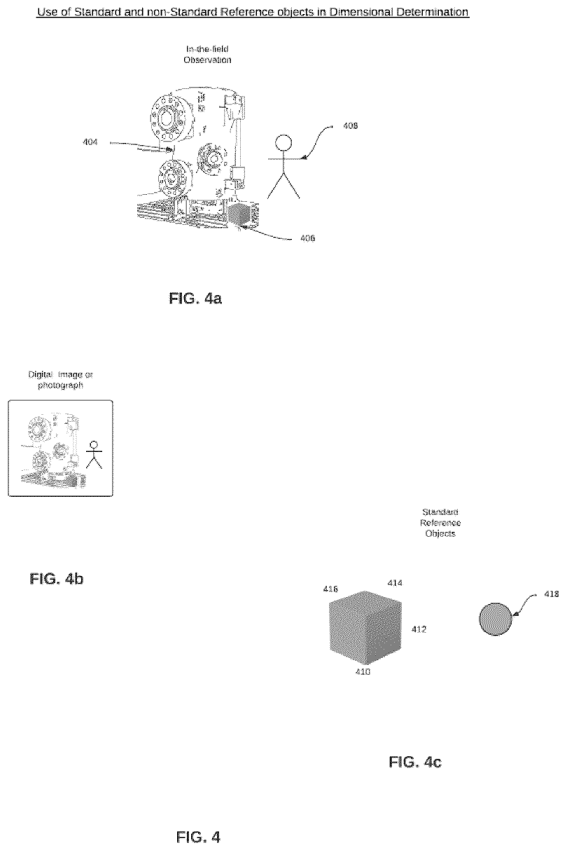

The first embodiment is illustrated with a digital photograph or image of the unidentified part 210 using a standard reference object; the process of photographing an unidentified part with a standard reference object is further detailed and illustrated in FIG. 4. The digital image 210 of an unidentified part and a standard object is illustrated both utilizing Artificial Intelligence/Machine Learning to determine the unidentified part dimensions 214 and human observation of the digital image to determine the unidentified part dimensions. Additionally in the embodiment illustrates that dimensions of the unidentified part can be determined by photographing the part with a non-standard reference object and using Artificial Intelligence/Machine Learning or human observation to determine the relative dimensions 218 of the unidentified part by comparing the part size to the non-standard object. Non-standard objects can be intentionally placed in the photographs or unintentionally placed if the dimensions of the non-standard object are known. Attention is given when taking photographs that the standard and non-standard objects are at a similar distance from the photographing device to allow for similar vantage point and relative sizing determinations to be made when reviewing the digital photographs.

The embodiment also allows dimensional determinations to be made when a digital image is not available, but an in-the-field observation can be made of the unidentified part 212, both human observations allow for the use of a standard reference object 216 or non-standard reference objects 218 to be used to determine the dimensional size of the unidentified object. Lastly, the embodiment contemplates a range of other methods for determining the size of the unidentified object using more sophisticated three-dimensional scanning devices or if available the use of simpler low-tech methods such as measuring wheel, retractable tape measure, or measuring stick 220. Once the dimensional determination has been completed, if it is part of the identification process, the information can be stored in the data layer illustrated in FIG. 1.

Using a reference object and storing the digital image of the unidentified part and the reference object in the data layer allows for dimensional determinations to be made at any point in the supply chain without physical interactions or needing access to a parts database with the stored dimensions or retained prior shipment documents. The use of the reference object for dimensional determination meant only to be an estimate which will allow a non-technical third party service provider the ability to determine the dimensional part attributes needed to identify parts more accurately.

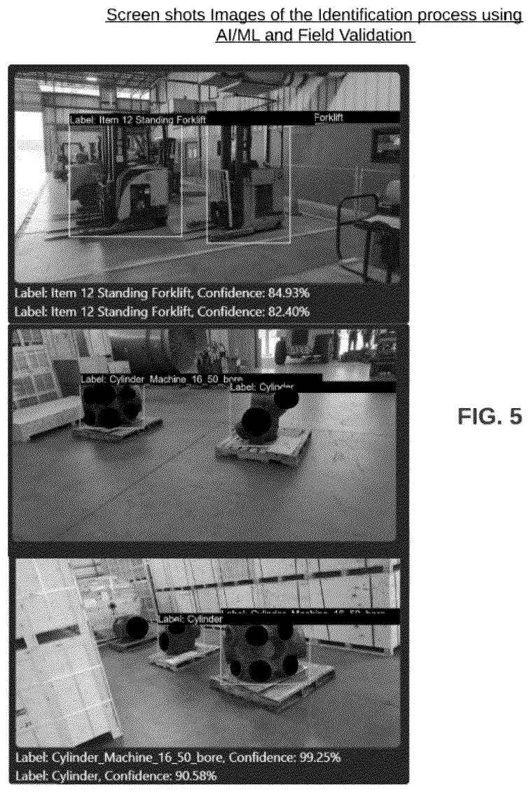

Referring now to FIG. 2b there is illustrated the process of using Artificial Intelligence/Machine Learning to identify the unidentified part using a digital image of the part. The embodiment illustrates the use of two different Artificial Intelligence/Machine Learning trained models to identify the unidentified part. First, the embodiment illustrates the use of an Artificial Intelligence/Machine Learning model trained with images of all the possible subset of parts in which the unidentified part could be included 222. A new image of the unidentified part 226 or a saved image from the data layer or the digital image embodied in FIG. 2a is loaded into the Artificial Intelligence/Machine Learning trained model. The Artificial Intelligence/Machine Learning trained model 222 outputs a part identification determination with a confidence probability as shown in more detail in FIG. 5. Additionally, the embodiment illustrates a second Artificial Intelligence/Machine Learning model trained on part attributes 224 of all possible subset of parts in which the unidentified part could be included.

The input for the Artificial Intelligence/Machine Learning part attribute trained model could include both an image of the unidentified part 228 or user data inputted of specific part attributes of the unidentified part 230, including dimensional information previously gathered or any other information stored in the data layer 200 about the unidentified part. The Artificial Intelligence/Machine Learning attribute trained model outputs a part identification determination with a confidence probability as shown in more detail in FIG. 5. Using both outputs from the Artificial Intelligence/Machine Learning image trained model 222 and Artificial Intelligence/Machine Learning attribute trained model 224 and the corresponding confidence probabilities can be merged in the summary process 232 either performed by a computer process or a human to make a more accurate part identification determination then store the summary conclusion in the data layer shown in the embodiment 200 or illustrated in more detail in FIG. 1.

Referring now to FIG. 2c there is illustrated the identification refinement method element. This method element provides additional accuracy for image identification is particularly important when the cost of incorrect part of identification is very high, the utilization of image identification using AI/ML results in a low confidence result, or the use of this method element can be completed inexpensively or quickly. The embodiment illustrates using the unidentified part's actual geographic location to reduce the subset of potential parts in which the unidentified part could be included 234.

In this embodiment the subset of parts 234 includes as a part attribute a site location that can be embodied as a geographic location in the database or the site location could be translated into a geographic location. The site location or geographic location associated with parts in the subset of parts database is compared to geographical input from the identification refinement process to return potential parts from the subset of parts in which have the highest confidence level based on geographical location information used to refine and either further increase the confidence level of the output from summary process 232 of FIG. 2b or to identify an error in identification and direct a more in-depth in-the-field or expert part evaluation.

The embodiment illustrates that that geographic data can come from user input 236, parsing the digital image metadata for geographic location of the unidentified part in the digital image or photograph 238, utilizing a subset of parts attribute database 234 to gather geographic location for each part in the subset of parts. Another embodiment includes using trade compliance data from prior compliance filings, such as filings with the US Customs or other national, state, or local jurisdictions, or prior shipment and transportation documents to identify and create a subset of parts at particular job sites 242 coupled with the job site geofenced area to correlate to that job site 244 to a geographical location.

Referring now to FIG. 2d, there is shown the method element of final field or digital validation. In the illustrated embodiment of the final field or digital validation, a user that has access to the original unidentified part 250, would confirm the outputs from the prior method elements resulting in parts and confidence levels 256, and would validate that the returned output parts actually match the physical attributes and dimensions of the unidentified part in-the-field 252. Additionally, a user could explore all part attributes of the output of returned parts from prior method elements steps by utilizing a subparts attribute database 254 examining only the part attributes for returned parts 256, and confirming again the physical unidentified part in-the-field to the attributes in the subpart data base for increased confidence that the unidentified part can be identified with a highest level of confidence.

If at any time during the method elements a user is not satisfied with the returned confidence level illustrated in FIG. 2b or output returned parts do not match with other data inputs from Identification Refinement FIG. 2c with part attributes from the subset of parts through Final Field of Digital Validation FIG. 2d, the user can restart the process or complete any method element not previously completed and restart the identification process over until an object is identified with an acceptable level of confidence.

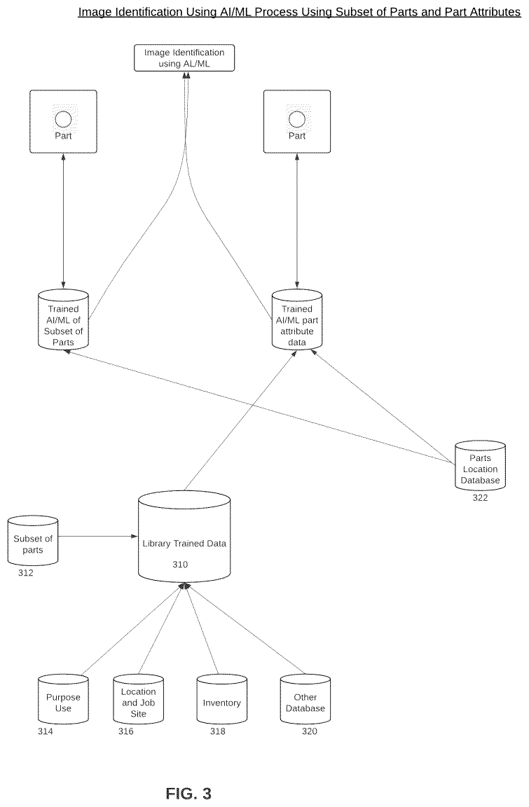

Referring now to FIG. 3, there is shown a detailed embodiment of the Image Identification method element using Artificial Intelligence/Machine Learning. This detailed embodiment illustrates the use of a trained data library of parts 310 to train more quickly train and build Artificial Intelligence/Machine Learning models for both image and part attributes outputs. The trained data library can be further limited and refined by utilizing additional databases that include selected subset of parts 312, purpose and use subset of parts 314, location and job site subset of parts 316, inventory subset of parts 318, or other databases with attributes for selecting subsite of parts 320 including a geographic location 322. By limiting the training data by using subsets allows for smaller less expensive training sets and training models. A high accuracy with a high level of confidence of part identification can still be achieved with smaller training sets, resulting in lower confidence AI/ML results, but secondary and tertiary validation in occurring the entire part identification process illustrated in FIG. 2.

Referring now to FIG. 4, there is shown the user of standard and non-standard reference objects in dimensional determinations. The embodiment in FIG. 4a illustrates an actual unidentified part 404 in-the-field environment with a standard reference object 406 next to the part 404. The embodiment illustrating the part 404 and the reference object 206 in close proximity allows for dimensional determination by comparing the size of both the part 404 and the reference object 206 and making a dimensional determination of the part 404 by knowing the dimensions of the reference object 406. Additionally, a similar determination can be made, as illustrated in the embodiment using a non-standard object 408, as long as the size of the non-standard object is known or can be estimated. The embodiment illustrates the non-standard reference object as a human, other embodiments might include known parts in proximity, unidentified part attributes such as bolt diameters, part orifices, or components of known size, other objects commonly in-the-field such as gravel, hand tools, or other non-standard objects of known size.

Referring now to FIG. 4c, there is illustrated a standard reference object 410 as a three-dimensional cube with known size parameters of length 416, width 414, and height 412. When photographed at a similar distance from the photographing device as the unidentified part, the standard reference objective and non-standard reference object can be used to determine the relative size of the unidentified part and its part attributes. While the embodiment illustrates a 3-dimensional reference object, other embodiments might include two-dimensional shapes 418, such as stickers, or images that could all be used as a standard reference object.

Referring now to FIG. 4b embodies a digital illustration of the unidentified part and the standard and non-standard reference objects. The digital photograph or image of the unidentified part can be saved and stored in the data layer for further use in the part identification process.

FIG. 5, illustrates the output from the trained Artificial Intelligence/Machine Learning image model embodied 222, which details the confidence level of the parts identified. This embodiment illustrates the use of the method elements on more than one unidentified part at once.

The invention claimed is:

1. A method for identifying and classifying non-serialized parts, the method comprising:
a. performing dimensional determination of a non-serialized part by capturing an image of the part alongside a reference object with known dimensions;
b. identifying the non-serialized part by processing dimensional data and part attributes using at least one of machine learning techniques, artificial intelligence, or computational methods;
c. refining the identification and classification by integrating additional data comprising at least one of geographic metadata, image metadata, user input location data, job site geofencing data, or trade compliance documentation;
d. classifying the identified non-serialized part based on the processed and refined data; and
e. validating the identified and classified non-serialized part using at least one of on-site verification or digital verification, including comparing part attributes against a reference database.

2. The method of claim 1, wherein the reference object is selected from the group consisting of a standardized three-dimensional object, a two-dimensional marker, a known part component, a human hand, or a common in-field object with known size.

3. The method of claim 1, wherein the dimensional determination estimates physical dimensions of the non-serialized part relative to the reference object through image analysis or direct measurement.

4. The method of claim 1, wherein the refining step reduces a subset of candidate parts based on geographic, job site metadata, or compliance data to increase identification confidence.

5. The method of claim 1, wherein the identifying and classifying steps utilize trained AI or ML models, comprising separate models for image-based recognition and part attribute recognition.

6. The method of claim 1, wherein the validation step further comprises human confirmation via visual inspection or comparison of part attributes to database records.

7. The method of claim 1, wherein the method is performed on a subset of parts in a company's inventory.

8. The method of claim 7, wherein the method is performed by a third-party service provider without requiring access to the entire part inventory or intimate technical knowledge of the parts.

9. The method of claim 1, wherein the method is performed at multiple points during the non-serialized part's logistics lifecycle to support ongoing trade compliance and supply chain documentation.

10. The method of claim 9, wherein the continued movement of the non-serialized part in the supply chain is facilitated by the identification, classification, and validation process.

11. A system for identifying and classifying non-serialized parts, the system comprising:
a. a part identification module configured to perform dimensional determination by analyzing an image of the part with a reference object and to identify non-serialized parts using at least one of machine learning techniques, artificial intelligence, or computational methods;
b. a classification module configured to classify the identified parts based on processed and refined data; and
c. a validation module configured to validate the identified and classified parts using on-site verification or digital verification, including comparing part attributes against a reference database.

12. The system of claim 11, wherein the identification module refines identification results by integrating geographic metadata, image metadata, user input location data, job site geofencing data, or trade compliance documentation.

13. The system of claim 11, wherein the system operates on a subset of a company's inventory and is operable by a third-party service provider without requiring full access to the entire inventory.

14. The system of claim 11, wherein the system facilitates identification, classification, and validation at multiple points in a supply chain logistics lifecycle.

15. The system of claim 11, wherein the validation module supports human-in-the-loop confirmation and automated confidence scoring of classification results.

16. A computer-readable medium having stored thereon computer-executable instructions which, when executed by a processor, cause the processor to perform the method of any one of claims 1 to 10.
